(19) United States
(12) Patent Application Publication
(10) Pub. No.: US 2010/0333021 A1
(43) Pub. Date: Dec. 30, 2010

(54) METHOD FOR OBTAINING INFORMATION CONCERNING CONTENT ACCESS AND RELATED APPARATUSES

(75) Inventor: Karima Rafes, Issy-Les Moulineaux (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: FRANCE TELECOM, Paris (FR)

(21) Appl. No.: 12/918,277

(22) PCT Filed: Feb. 17, 2009
(86) PCT No.: PCT/FR2009/050251

§ 371 Date: Aug. 18, 2010

(30) Foreign Application Priority Data
Feb. 18, 2008 (FR) 0851006

(51) Int. Cl. G06F 3/048

(52) U.S. Cl. 715/810

(57) ABSTRACT

The invention relates to a method for obtaining information concerning the access to a plurality of content accessible by individuals having access apparatuses (I). To this end, the method comprises obtaining a graphical representation including aggregated information on an amount of accesses of at least one piece of content from the plurality of content by a panel of individuals, the panel of individuals including individuals accessing or having accessed at least one piece of content of a subassembly of content of the plurality of content, and controlling a display of said graphical representation so that a user can select at least one piece of content from the displayed graphical representation.

The present invention relates to the obtaining of information relating to content access.

The term “content” should be understood to mean any type of information, regardless of its nature (text, sound, video, film, television program, etc.), its form (analog, digital) and its access mode (television, computer network such as the internet, telephone network, radiocommunication network, etc.).

The number of content sources is now considerable. If only in the television domain, tens and even hundreds of channels are currently accessible to the general public. If information sources available via the internet for example are included, this number actually becomes difficult to quantify.

In light of this proliferation, it is therefore difficult for an individual to identify one or more contents that he might have an interest in accessing, and all the more so if he does not precisely know what type of content he wants to access at a given instant.

In particular, reading previously designed content guides, televised program guides for example, can be fairly time-consuming and require a sustained intellectual effort. Furthermore, any reviews that these guides might contain are very subjective and do not therefore always constitute relevant suggestions.

Moreover, the known automatic content search help methods do not make it possible to identify, with a good level of certainty, contents that are likely to be of interest to a user. This is largely explained by the inability of a machine to determine the tastes of a user, or of the user to express his tastes in a way that can be understood by a machine.

As an example, program selection using categories and/or keywords may prove ineffective. In practice, two contents of the same category, for example “entertainment”, responding to the same keyword, for example “music”, may be appreciated very differently by a user. Such is the case, for example, if the first duly identified content corresponds to a modern music clip while the second content corresponds to a classical music concert.

Furthermore, such a method requires an indexing of each content to be put in place, for example so that said content can be assigned a category and keywords, which may be tedious and is not without errors.

For its part, a publisher or a content distributor may have difficulty in assessing the success of the distribution of his content, given the existence of competing contents and the diversity of content users.

One aim of the present invention is to improve this situation.

The invention thus proposes a client system or device for obtaining information relating to accesses to a plurality of contents accessible to individuals having access appliances. This system or device comprises:
means for obtaining a graphic representation comprising aggregate information relating to a quantity of accesses to at least one content from the plurality of contents by a panel of individuals, the panel of individuals consisting of individuals accessing or having accessed at least one content of a subset of the plurality of contents, and
means for controlling a display of said graphic representation, so as to enable a user to select at least one content from the graphic representation displayed.

Recourse to a duly constructed panel of individuals makes it possible to retain individuals according to the contents that they access, that is to say, their behavior, or even their tastes.

Furthermore, the aggregation, over the panel of individuals, of information relating to the quantity of accesses makes it possible to exploit the collective intelligence, while being able to preserve the anonymity of the individuals forming the panel.

Advantageously, the aggregate information obtained relates to a quantity of accesses to each content of the plurality of contents accessed by the panel of individuals. However, information on the contents that are most accessed for example is not all that is required.

Depending on the mode of access to the contents of the plurality of contents, for example synchronous or asynchronous mode, the way the panel is constructed and/or how the aggregate information is obtained may vary. As an example, there may be an interest in obtaining aggregate information substantially in real time for contents accessible in synchronous mode.

The means for controlling a display of the graphic representation may include a hardware or software module capable of generating and transmitting a control signal and/or a video signal intended to trigger the display of the graphic representation. If the client system or device concerned has display means, such as a screen, the control signal and/or video signal will advantageously be routed in an appropriate manner to show the graphic representation on these display means. Otherwise, the control signal and/or video signal may advantageously be transmitted to an external entity, having display means, such as a screen, capable of displaying said graphic representation.

The system or device may, possibly, include means for accessing at least one content of the plurality of contents. These access means may comprise any entity capable of restoring, in a visual and/or audible, or other manner, a selected content to a user. The access means may, for example, comprise a display screen possibly associated with a loudspeaker. The access means include a software or hardware module controlling/driving such an entity.

As a variant, the content may be accessed using another system or device.

The system or device may advantageously include means for selecting said subset of the plurality of contents. By so doing, it can participate in the construction of the panel of individuals and influence the graphic representation obtained.

These selection means can take any form that can be envisaged. As nonlimiting examples, they may include a navigation tool within the graphic representation displayed, associated with a tool for validating an option where the navigation has stopped, such as a keyboard, a mouse, a scroll wheel, a joystick, or other. They also include a software module for processing information and data supplied by the navigation tool and/or the validation tool. They may be arranged so as to make a local selection or to transmit an item of information representative of the selection made to a remote entity (for example using a remote control).

The selection of a content using selection means is done from the graphic representation displayed and it may possibly allow the selected content to be accessed.

The invention also proposes a method for obtaining information relating to accesses to a plurality of contents accessible to individuals having access appliances. The method comprises the following steps:
obtaining a graphic representation comprising aggregate information relating to a quantity of accesses to at least one content of the plurality of contents by a panel of individuals, the panel of individuals consisting of individuals accessing or having accessed at least one content of a subset of contents of the plurality of contents, and
controlling a display of said graphic representation, so as to enable a user to select at least one content from the graphic representation displayed.

The invention also proposes a computer program comprising code instructions arranged to implement, when loaded and run by a data processor, the following steps to obtain information relating to accesses to a plurality of contents accessible to individuals having access appliances:
obtaining a graphic representation comprising aggregate information relating to a quantity of accesses to at least one content of the plurality of contents by a panel of individuals, the panel of individuals consisting of individuals accessing or having accessed at least one content of a subset of contents of the plurality of contents, and
controlling a display of said graphic representation, so as to enable a user to select at least one content from the graphic representation displayed.

The invention also proposes a server arranged to cooperate with a client system or device as mentioned above. This server comprises:
means for receiving information relating to accesses to a plurality of contents accessible to individuals having access appliances, and
means for producing and transmitting to the client system or device aggregate information relating to a quantity of accesses to at least one content of the plurality of contents by a panel of individuals, the panel of individuals consisting of individuals accessing or having accessed at least one content of a subset of the plurality of contents.

According to other aspects listed hereinbelow, the invention thus proposes a method for obtaining information relating to accesses to a plurality of contents accessible to individuals having access appliances. According to this method, aggregate information is obtained that relates to a quantity of accesses to at least one content of the plurality of contents by a panel of individuals, the panel of individuals consisting of individuals accessing or having accessed a given subset of the plurality of contents.

The invention also proposes a use of the abovementioned method, to assist in the identification of contents for a user having access to a plurality of contents using an access appliance. In this use, the subset of the plurality of contents is determined by a selection by the user.

A user is thus able to find contents likely to be of interest to him, for example by virtue of the similarity of his behavior and/or tastes with the panel of individuals that he himself has helped to define.

The invention also proposes a use of the abovementioned method, to assess the success of the distribution of a content of the plurality of contents to a given panel of individuals.

This use may be of particular use to a publisher or a content distributor for example.

Other uses of the abovementioned method can also obviously be envisaged.

The invention also proposes a system arranged to contain information relating to accesses to a plurality of contents accessible to individuals having access appliances. This system comprises means for obtaining aggregate information relating to a quantity of accesses to at least one content of the plurality of contents by a panel of individuals, the panel of individuals consisting of individuals accessing or having accessed a given subset of the plurality of contents.

The invention also proposes a client device comprising:
means for selecting a subset of a plurality of contents, the plurality of contents being accessible to individuals having access appliances; and
means for obtaining aggregate information relating to a quantity of accesses to at least one content of the plurality of contents by a panel of individuals, the panel of individuals consisting of individuals accessing or having accessed the subset of the plurality of contents selected by said selection means.

The invention also proposes a computer program comprising code instructions arranged to implement the following steps, when loaded and run on a client device:
selecting a subset of a plurality of contents, the plurality of contents being accessible to individuals having access appliances; and
obtaining aggregate information relating to a quantity of accesses to at least one content of the plurality of contents by a panel of individuals, the panel of individuals consisting of individuals accessing or having accessed the subset of the plurality of contents selected by said selection means.

The invention also proposes a server arranged to produce information relating to accesses to a plurality of contents accessible to individuals having access appliances. This server comprises means for producing aggregate information relating to a quantity of accesses to at least one content of the plurality of contents by a panel of individuals, the panel of individuals consisting of individuals accessing or having accessed a given subset of the plurality of contents.

The invention finally proposes a computer program comprising code instructions arranged to, when loaded and run on a server, produce aggregate information relating to a quantity of accesses to at least one content of a plurality of contents accessible to individuals having access appliances by a panel of individuals, the panel of individuals consisting of individuals accessing or having accessed a given subset of the plurality of contents.

Other particular features and advantages of the present invention will become apparent from the following description of nonlimiting exemplary embodiments, with reference to the appended drawings in which:

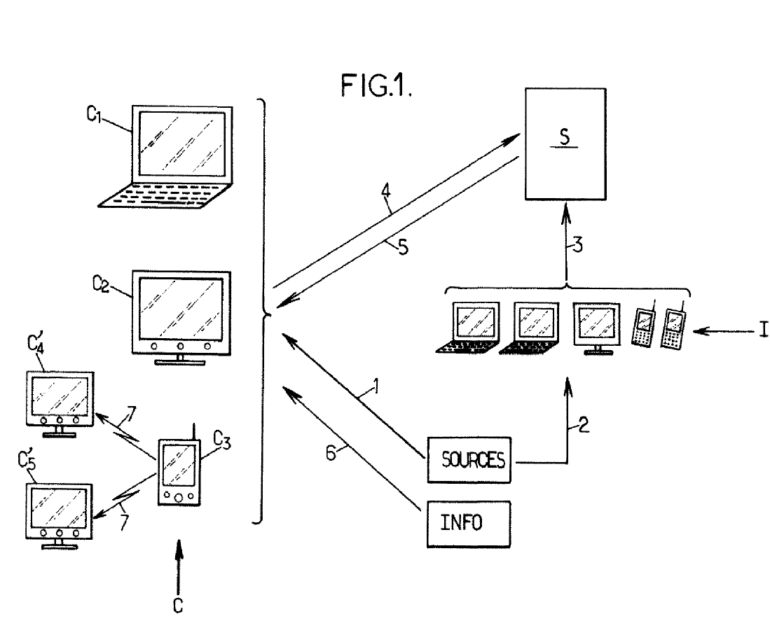

FIG. 1 is a diagram showing an example of the architecture and information interchanges according to a nonlimiting exemplary embodiment of the invention;

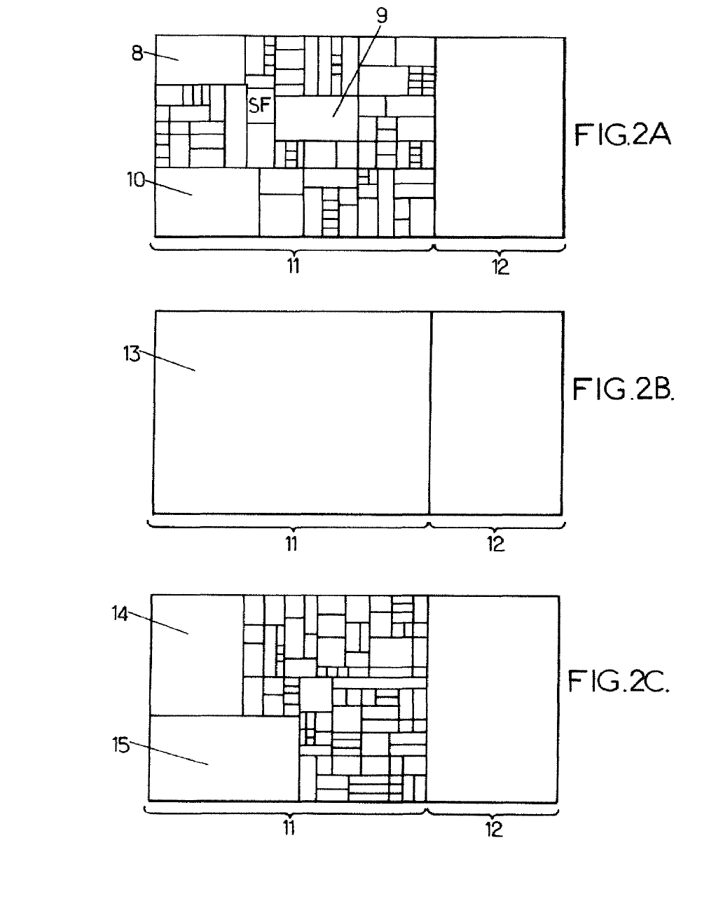

FIGS. 2A-2C are diagrams showing, at successive instants, an example of the graphic interface likely to be presented to the user of the client device according to a nonlimiting exemplary embodiment of the invention.

FIG. 1 shows an exemplary system for obtaining information relating to content accesses by individuals.

To this end, some sources make contents accessible to a plurality of individuals. The contents delivered by these sources may involve any kind of information, as reviewed in the introduction.

The individuals who have access to these content sources consist of a user having a client system or device C, which may be one or more of the following: a computer C1, a television set C2, a portable communication tool such as a cell phone C3, a decoder module or set-top box, any combination of the abovementioned entities, or similar (arrow 1). They also comprise the individuals who have access appliances, denoted I, which cover any kind of access appliances, such as computers, television sets, portable communication tools, etc. (arrow 2).

Moreover, a server S is informed of the accesses, by the individuals having access appliances I, to the contents delivered by the sources. This can be done in any of the ways that can be envisaged.

For example, probes may be arranged in at least some of the access appliances I and the server S, these probes being suitable for detecting and indicating to the server S each access to content delivered by the sources. As a variant, each individual having an access appliance I could voluntarily indicate to the server S the contents that he accesses.

The information collected in this way by the server S therefore identifies each of the content accesses made using the access appliances I (arrow 3). The nature of the information transmitted to the server S and/or the transmission mode used can be adapted according to the requirements. As an example, it will be possible to envisage having only the content accesses that occur during a minimum time period indicated to the server S, in order to avoid counting fleeting access to contents (channel hopping).

The server S stores the information relating to the accesses obtained in this way in a memory that is associated with it, and that may be internal or external to this server.

For its part, the client device C cooperates with the server S to define a panel of individuals that represent a subpart of the users of the access appliances I. As a variant, the panel of individuals could be defined by the client device C alone, by the server S alone, or even using an intermediate entity (not represented in FIG. 1).

The panel of individuals is defined as a subset of the users of the access appliances I, whose content accesses are or have been communicated to the server S. It more specifically consists of individuals accessing or having accessed at least one content of a given subset of the contents obtained from the sources mentioned above.

In the example illustrated in FIG. 1, the client device C transmits to the server S, information relating to a given subset of contents (arrow 4). This subset of contents, which may comprise one or more contents, advantageously results from a content selection made by the user of the client device C. It will be noted that such a selection could also be made by means other than via the client device C, for example via a web interface offered by the supplier of the accessible contents.

Selection may, for example, consist in choosing one or more contents from a set of accessible contents, presented to the user in a graphic representation, using display means of the client device C (or display means controlled by the client device C). This selection is made by the user of the client device C only with a view to defining the panel of individuals. The graphic representation concerned may be that which will be described below with reference to FIGS. 2A-2C.

In this case, the selected subset of contents may relate to a single content chosen by the user, or all the accessible contents apart from one of the contents that has been explicitly excluded by the user of the client device C.

By default, in the absence of any content selection, it can be considered that the subset of contents consists of all the accessible contents.

As a variant, the selection of the subset of contents may consist of a choice by the user of the client device C, for the purposes of personal access to this subset of contents.

Thus, the choice, by the user of the television set C2, of a televised program from the plurality of contents delivered by the sources could be accompanied by the viewing of this program by this user.

In the case where the client device is a portable communication tool, such as the cell phone C3, this could advantageously work as a remote control for an access appliance such as one of the television sets C′4 or C′5. To this end, the cell phone C3 could be adapted to deliver an appropriate control signal 7, such as an infrared signal for example. The selection of a subset of contents could thus result from the choice of a program using such a remote control, for the purposes of access on one of the remotely controlled appliances.

Obviously, the operations mentioned hereinabove may be repeated as many times as necessary, until a desired subset of contents is obtained.

In addition, other criterion may also be used to define the panel of individuals.

Thus, a geographic criterion, an accessible content type, a content distribution mode and/or a criterion for selecting individuals may be used to determine the relevant panel of individuals.

As an illustration, the panel of individuals could be made up of individuals, from all the individuals having access appliances I for which the server S has collected access information, who access or have accessed a televised program selected by the user of the client device C, and who, moreover, perform their content accesses in France, from television sets, in an analog format, via the microwave broadcast channels X or Y.

According to another illustrative example, the panel of individuals could consist of individuals who access or have accessed a video selected by the user of the client device C, and who, moreover, access videos in MPEG format, these accesses being made from the websites X′ or Y′, via an access provider Z.

It will be noted that, in these examples, the panel of individuals is defined in total anonymity, the user of the client device C knowing nothing of the identity of the individuals forming the panel.

As a variant, the panel of individuals could be constructed by taking into account certain criteria for selecting individuals, such as an age range for example. The panel could even include individuals specifically selected according to their identity, for example friends of the user of the client device C.

From the choices made by the user of the client device C and transmitted to the server S, said server aggregates, for the panel of individuals resulting from these choices, the information relating to the content accesses obtained from the access appliances I.

The aggregate information relates to the quantity of accesses to at least one content by the panel of individuals.

Advantageously, it relates to the quantity of accesses to each content accessed by the panel of individuals. The quantity of accesses is thus available not only for the contents most accessed by the panel of individuals, but also for the contents that are least accessed.

The aggregate information may then be transmitted to the client device C (arrow 5), for example at the request of the client device. The user of the client device C may thus have an audience of one, several or all the contents accessed by the panel of individuals.

The client system or device C thus comprises a software and/or hardware module designed to obtain a graphic representation comprising the aggregate information received from the server S. This graphic representation may be that which will be described below with reference to FIGS. 2A-2C, or similar. Depending on the nature of the client system or device C, the graphic representation may be obtained in a directly-displayable form, or it may consist of all the information necessary for it to be graphically formatted prior to its display.

When the client system or device C includes display means, it can control the latter to display said graphic representation.

Otherwise, for example when it is a set top box that does not have its own display means but which may be associated with another device (display screen, typically) provided with display means, it can control the display of the graphic representation on this associated device. To this end, the set top box may transmit to the associated device a control signal and/or video signal intended to trigger the display of this graphic representation. After this signal has been received and processed, the associated device can then display the graphic representation. A content selection by the user of the client system or device C from the graphic representation displayed is then possible, as appropriate.

When at least some of the contents delivered by the sources are accessible in synchronous mode, the aggregate information for the panel of individuals may advantageously be obtained in real time. In this case, the client device can obtain an instantaneous audience of the contents within the panel of individuals.

When the contents delivered by the sources are accessible in asynchronous mode, the aggregate information obtained for the panel of individuals is more representative of a quantity of accesses over an observation period which may be determined by default or be chosen by the user of the client device C for example.

In all cases, the information relating to the quantity of content accesses respects the anonymity of the individuals forming the panel, because of its aggregation for all the panel of individuals.

Advantageously, the client device C may also receive information relating to the contents delivered by the content sources, such as descriptions of these contents including, for example, a summary, a duration indication, a format, or other information (arrow 6).

In this case, a link is advantageously made between the contents accessible to the client device C from the content sources and said information describing the contents.

For example, the aggregate information obtained from the server S may be highlighted in a graphic representation relating to the contents accessible on the client device C, related to said content description information.

The operations described in the above example can be implemented using computer programs comprising appropriate code instructions, on the client device C, the server S and/or any other intermediate entity.

The embodiment of the invention that has just been described provides help in identifying contents for the user of the client device C.

This help in identifying contents may be based on a similarity of behavior between this user and at least some of the individuals having access appliances I. Such is the case in particular when each content selection by the user for access purposes is taken into account to form the panel of individuals.

The user of the client device C may then obtain information on the quantities of accesses from a panel of individuals exhibiting behavior similar to his own, that is to say, whose individuals access or have accessed the same contents that he has accessed. Such information may constitute suggestions concerning contents to be accessed for this user.

As a variant, the help in identifying contents for the user of the client device C may be based on a similarity of taste or interest. Such is the case, for example, when the panel of individuals is made up from deliberate selections by the user of contents corresponding to his personal tastes. The aggregate access quantities obtained may thus enable this user to detect contents much accessed by a panel of individuals having tastes similar to his own.

The embodiment that has just been described offers a certain number of advantages.

In particular, the mechanism described hereinabove is fairly sparing in terms of memory space, quantity of calculations and signaling exchanged.

In practice, the server S may make do with storing a correlation between the contents accessed by the users of the access appliances I (for example, a simple identifier of each of these contents), the information relating to the quantity of accesses to the contents and the information relating to each defined panel of individuals (for example, a simple panel identifier).

Furthermore, the contents, and the information describing these contents, are not stored on the server S, but on one or more other elements such as servers.

Finally, the aggregate information relating to the quantity of accesses to the contents is obtained on the client device C on completion of a simple message interchange (arrows 4 and 5). By having this aggregate information pushed from the server S to the client C, the transmission of additional requests and responses is avoided.

Furthermore, the server S may have information relating to the quantities of accesses to the contents that is very up-to-date. Such may also be the case with the client device C, when the aggregate information is transmitted to it by the server S in a reactive manner. The user of the client device C may then have information substantially in real time. As an example, the information obtained on the client device C could be updated every 5 minutes or less.

Architectures and/or operating modes other than those that have been described with reference to FIG. 1 can obviously be envisaged, as will be apparent to those skilled in the art.

An exemplary application of the invention will now be described with reference to FIGS. 2A-2C.

Each of these figures shows, at successive instants, a graphic interface that is likely to be presented to the user of the client system or device C by display means. These display means may, for example, consist of a screen of a client device C. When the client device C does not have display means, for example in the case of a set top box, the display means used may be those of an associated device (possibly forming, with the set top box, a client system C).

The graphic interface is divided into two parts. The part 11 contains a graphic representation of information relating to a quantity of accesses to at least one content delivered by the sources. This representation can be in a variety of forms.

In the examples illustrated in FIGS. 2A-2C, each content is represented by a rectangle, the size of which depends on the quantity of accesses to this content by a panel of individuals constructed previously, for example according to a proportionality criterion. Obviously, other forms of representation can also be envisaged, such as a color code representative of the quantity of accesses by the panel of individuals, or others.

As for the part 12 of the graphic interface, this may, for example, be reserved for the display of a given content, possibly selected from the graphic representation 11. Such is, for example, the case if the client device C is also an access appliance.

As a variant, the part 12 may be used to display information describing a content possibly selected from the graphic representation 11. Such information may include descriptions of a fairly general nature, for example when a pointer, such as that of a computer mouse, is positioned on a given content in the graphic representation 11. It may include detailed descriptions, for example when a given content has been selected by a mouse click on the corresponding rectangle of the graphic representation 11, or by some other action.

The graphic interface illustrated in FIG. 2A corresponds, for example, to a first instant, when the user of the client device C has not yet selected content from the set of available contents. At this instant, the panel of individuals therefore consists of all the individuals having access appliances I.

In the graphic representation 11 of FIG. 2A, a large quantity of contents accessed, represented by respective rectangles, can be distinguished. Among these contents, the contents 8, 9 and 10 appear to be the most accessed, as indicated by the large size of the corresponding rectangles.

The user of the client device C is then assumed to select one of the contents, for example from the graphic representation 11 of FIG. 2A. This content may be any of the contents accessible to this user. It may, for example, be a televised science-fiction series, denoted SF in FIG. 2A. This selection may, possibly, be accompanied by the display of this televised series in the part 12 of the graphic interface.

The selection of the content SF causes the definition of the panel of individuals constructed relative to the user of the client device C to be modified. The panel of individuals is thus reduced to the individuals having access appliances I who are currently accessing the televised series SF selected by the user. It should be noted that this example presupposes a synchronous content broadcast mode, although an access in asynchronous mode, or even by a combination of the synchronous and asynchronous modes, is also possible.

Immediately after the televised series SF has been selected by the user of the client device C, the graphic interface that is presented to him is modified as illustrated in FIG. 2B. It can be seen that the part 11 of this graphic interface now shows only one content 13 accessed by the panel of individuals that has just been defined. This is explained by the fact that, at this instant, all the individuals forming the panel are currently accessing the televised series SF, which corresponds to the content 13.

At a subsequent instant, for example after the end of the broadcasting of the televised series SF, the graphic interface presented to the user of the client device C may be of the type illustrated in FIG. 2C. In the part 11 of this graphic interface, all the contents accessible to the panel of individuals at this observation instant can be distinguished. Out of all these contents, the contents 14 and 15 appear to have been most accessed by the panel of individuals, as indicated by the size of the corresponding rectangles.

It is possible for the contents 14 and 15 to also consist of televised science fiction series, which may include the series SF itself and/or other series. In any case, they are contents most avidly followed, and therefore no doubt appreciated, by the followers of the series SF.

In this way, the user of the client device C may discover contents that are likely to please him, by exploiting the collective intelligence of the panel of individuals that he himself has helped to define.

A different graphic representation, but one organized according to the same principles, would be observed at subsequent observation instants.

Furthermore, the user of the client device C could continue to modify the panel of individuals, at a subsequent instant. This could be done, for example, by selecting, or, on the contrary, by excluding, one or more of the contents appearing in the graphic representation 11 at that instant.

It is also possible to revert to a prior definition of the panel of individuals, for example using a history of the states of this panel, or even construct an entirely new panel of individuals.

Naturally, many other graphic representations than those illustrated in FIGS. 2A-2C may be used in the context of the present invention. In particular, when the access appliances I have access to the contents in asynchronous mode, the graphic representation advantageously shows the contents having been accessed over a given observation period, rather than the contents that are currently being accessed in real time.

Similarly, the aggregate information relating to the quantity of content accesses by the panel of individuals may be presented in various forms, replacing or complementing the graphic representation that has just been described. It is possible, for example, to consider a presentation indicating the absolute number of accesses to each content accessed, or even the proportion of accesses to each content as a percentage.

Although the present invention has been more particularly described in its application as help in identifying as contents for a user, other applications are also possible.

In particular, the obtaining of aggregate information relating to the quantity of content accesses by a panel of individuals may be used, for example, by a publisher or a content distributor, to evaluate the success of the distribution of a content to a given panel of individuals.

This may, for example, be used to verify whether a target audience has indeed been reached, determine whether non-target audiences have been reached, or even work out a typology of the individuals having accessed a content.

This may also be used to monitor the trend of the audience of a content or of a set of contents within a given panel of individuals, in relation to other contents.

1. A client system or device for obtaining information relating to accesses to a plurality of contents accessible to individuals having access appliances (I), comprising:
means for obtaining a graphic representation comprising aggregate information relating to a quantity of accesses to at least one content from the plurality of contents by a panel of individuals, the panel of individuals consisting of individuals accessing or having accessed at least one content of a subset of the plurality of contents, and
means for controlling a display of said graphic representation, so as to enable a user to select at least one content from the graphic representation displayed.

2. The client system or device as claimed in claim 1, also including means for accessing at least one content of the plurality of contents, said access means being activated in response to the selection by a user from the graphic representation displayed.

3. The client system or device as claimed in claim 1, also including means for selecting said subset of the plurality of contents.

4. The client system or device as claimed in claim 1, including a portable communication tool (C3) comprising means for transmitting, to at least one access appliance (C′4, C′5), an indication of said subset of the plurality of contents.

5. The client system or device as claimed in claim 1, in which the means for obtaining a graphic representation are arranged to obtain aggregate information relating to a quantity of accesses to each content of the plurality of contents accessed by the panel of individuals.

6. The client system or device as claimed in claim 1, in which the panel of individuals is also made up from at least one criterion out of: a geographic criterion, an accessible content type, a content distribution mode and a criterion for selecting individuals.

7. The client system or device as claimed in claim 1, in which the means for obtaining a graphic representation are arranged to obtain aggregate information substantially in real time.

8. The client system or device as claimed in claim 1, also comprising means for obtaining information describing at least one content of the plurality of contents.

9. A method for obtaining information relating to accesses to a plurality of contents accessible to individuals having access appliances (I), the method comprising the following steps:
obtaining a graphic representation comprising aggregate information relating to a quantity of accesses to at least one content of the plurality of content by a panel of individuals, the panel of individuals consisting of individuals accessing or having accessed at least one content of a subset of contents of the plurality of contents, and
controlling a display of said graphic representation, so as to enable a user to select at least one content from the graphic representation displayed.

10. The method as claimed in claim 9, in which said graphic representation is obtained in response to a selection of said subset from said plurality of contents.

11. A computer program comprising code instructions arranged to, when loaded and run by a data processor, implement the following steps in order to obtain information relating to accesses to a plurality of contents accessible to individuals having access appliances (I):
obtaining a graphic representation comprising aggregate information relating to a quantity of accesses to at least one content of the plurality of contents by a panel of individuals, the panel of individuals consisting of individuals accessing or having accessed at least one content of a subset of contents of the plurality of contents, and
controlling a display of said graphic representation, so as to enable a user to select at least one content from the graphic representation displayed.

12. A server (S) arranged to cooperate with a client system or device as claimed in any one of claims 1 to 8, the server comprising:
means for receiving information relating to accesses to a plurality of contents accessible to individuals having access appliances (I), and
means for producing and transmitting to the client system or device aggregate information relating to a quantity of accesses to at least one content of the plurality of contents by a panel of individuals, the panel of individuals consisting of individuals accessing or having accessed at least one content of a subset of the plurality of contents.
